(19) United States
(12) Patent Application Publication
(10) Pub. No.: US 2009/0224196 A1
(43) Pub. Date: Sep. 10, 2009

(54) COMPACT SERVO POPPET VALVE AND PRESSURE RELIEF SYSTEM EMPLOYING THE SAME

(75) Inventors: Justin A. Tanner, Queen Creek, AZ (US); Ed Kesner, Mesa, AZ (US); Javier Gutierrez, Chandler, AZ (US); Michael Lawrence, Tempe, AZ (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: Honeywell International Inc., Morristown, NJ (US)

(21) Appl. No.: 12/042,085

(22) Filed: Mar. 4, 2008

(51) Int. Cl. F16K 1/00

(52) U.S. Cl. 251/321

(57) ABSTRACT

In one embodiment, a servo poppet valve is provided that includes a valve housing having a flow passage therethrough, a poppet valve element disposed in the flow passage, and a first spring washer disposed between the valve housing and the poppet valve element. The poppet valve element is movable between an open position and a closed position, and the first spring washer biases the poppet valve element toward the closed position.

### TECHNICAL FIELD

The present invention relates generally to a poppet valve and, more particularly, to a compact servo poppet valve employing one or more spring washers.

### BACKGROUND

Poppet valves are commonly utilized to regulate the pressure within a pressurized chamber of a hydraulic or pneumatic device. One known servo poppet valve comprises a valve housing having a flow passage therethrough. The flow passage is fluidly coupled between the pressurized chamber of the host device and a low pressure source, which may be, for example, the interior of the device or an ambient air source. A poppet valve element (e.g., a plunger) is disposed within the valve housing and adapted to move between: (i) a closed position wherein the valve element substantially impedes fluid flow through the flow passage, and (ii) an open position wherein the valve element does not substantially impede fluid flow through the flow passage. The poppet valve element is biased toward the closed position by an elongated helical spring (also commonly referred to as a “coil spring”). When the pressure within the pressurized chamber surpasses a predetermined pressure threshold, the force exerted on the exposed area of the poppet valve element exceeds the bias force exerted by the helical spring (and any force exerted on the valve element by the low pressure source). The poppet valve element consequently moves into an open position, and the helical spring is compressed between the poppet valve and an inner wall of the valve housing. When the poppet valve element is in the open position, fluid is permitted to flow from the pressurized chamber, through the poppet valve, and into the low pressure source thus relieving the pressure within the pressurized chamber. The poppet valve element remains in the open position until the pressure of the fluid within the pressurized chamber again falls below the predetermined pressure threshold.

Servo poppet valves of the type described above are well-suited for many applications. However, due in large part to the presence of the helical spring, such servo poppet valves may be undesirably heavy and/or bulky for utilization in applications wherein weight and volume are primary drivers. This is especially true when the helical spring employed by the servo poppet valve is characterized by a relatively high spring rate. There thus exists an ongoing need to provide a servo poppet valve that is relatively compact and lightweight. Preferably, such a servo poppet valve would be able to achieve a relatively high spring rate while maintaining the valve's compact size. Similarly, there exists an ongoing need to provide a pressure relief system employing such a compact servo poppet valve. Other desirable features and characteristics of the present invention will become apparent from the subsequent Detailed Description and the appended claims, taken in conjunction with the accompanying drawings and this Background.

### BRIEF SUMMARY

In a first embodiment, a servo poppet valve is provided that includes a valve housing having a flow passage therethrough, a poppet valve element disposed in the flow passage, and a first spring washer disposed between the valve housing and the poppet valve element. The poppet valve element is movable between an open position and a closed position, and the first spring washer biases the poppet valve element toward the closed position.

In a second embodiment, a pressure relief system is provided for fluid communication with a low pressure source. The pressure relief system includes: (i) a system housing having a pressurized chamber therein, and (ii) a servo poppet valve. The servo poppet valve includes a valve housing fixedly coupled to the system housing, a flow passage formed through the valve housing and fluidly coupled between the pressurized chamber and the low pressure source, and a poppet valve element disposed in the flow passage and movable between an open position and a closed position. The poppet valve element permits fluid flow from the pressurized chamber to the low pressure source in the open position. A spring washer is disposed between the valve housing and the poppet valve element and biases the poppet valve element toward the closed position. The poppet valve element normally resides in the closed position and is configured to move into the open position when the pressure of the fluid within the pressurized chamber surpasses a predetermined pressure threshold.

### BRIEF DESCRIPTION OF THE DRAWINGS

At least one example of the present invention will hereinafter be described in conjunction with the following figures, wherein like numerals denote like elements, and:

FIG. 1 is an isometric cross-sectional view of a compact servo poppet valve employing a stack of bellville washers in accordance with a first exemplary embodiment;

FIG. 2 is a high level schematic of an exemplary pressure relief system employing the compact servo poppet valve shown in FIG. 1; and

FIG. 3 is an isometric view of a stack of wave springs that may be utilized in place of the stack of bellville washers employed by the compact servo poppet valve shown in FIG. 1 in accordance with a second exemplary embodiment.

### DETAILED DESCRIPTION

The following Detailed Description is merely exemplary in nature and is not intended to limit the invention or the application and uses of the invention. Furthermore, there is no intention to be bound by any theory presented in the preceding Background or the following Detailed Description.

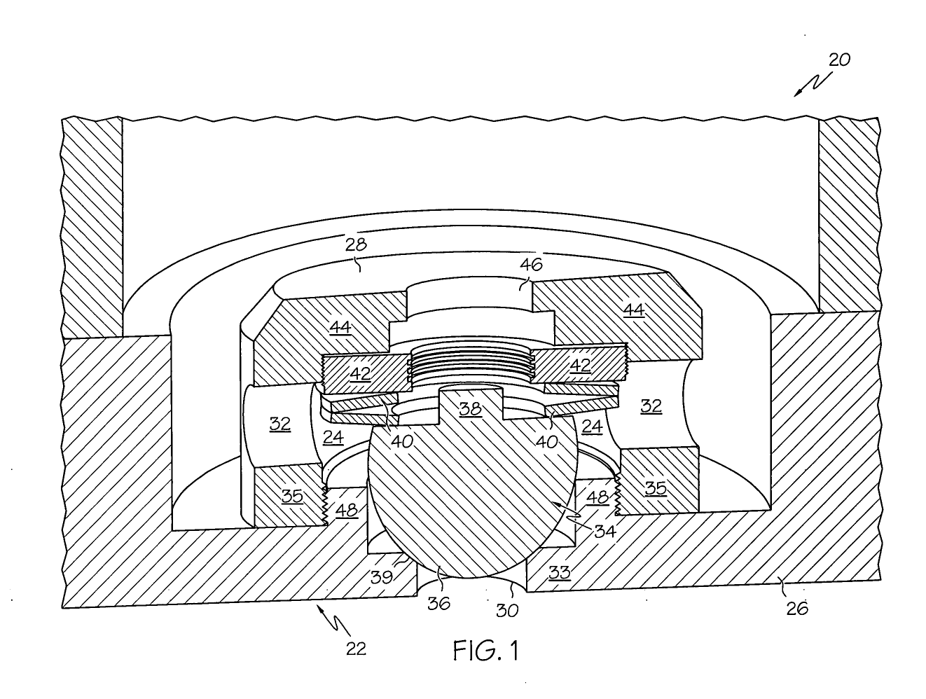

FIG. 1 is an isometric cross-sectional view of a compact servo poppet valve 20 in accordance with an exemplary embodiment. Poppet valve 20 comprises a valve housing 22 through which a flow passage 24 is formed. In the illustrated exemplary embodiment, valve housing 22 comprises a main housing body 26 having a housing cap 28 coupled thereto. Housing cap 28 is preferably removably coupled to main housing body 26 by way of a threaded interface, although housing cap 28 may be coupled to main housing body 26 utilizing any suitable attachment means (e.g., via one or more fasteners, such as a snap ring). Flow passage 24 includes at least one inlet 30 and at least one outlet 32, which may be formed through main housing body 26 and housing cap 28, respectively. For example, and as indicated in FIG. 1, inlet 30 may comprise a single channel that extends through a base wall 33 of main housing body 26, and outlet 32 may comprise a plurality of channels that extends through an annular sidewall 35 of housing cap 28.

A poppet valve element 34 is disposed between main housing body 26 and housing cap 28. In the illustrated example, poppet valve element 34 includes a substantially hemi-spherical seating portion 36 and a stemmed portion 38 extending therefrom; however, it will be appreciated that valve element 34 may assume any form suitable for selectively impeding fluid flow through flow passage 24 in the manner described below. Valve element 34 is movable between a closed position (shown in FIG. 1), a fully open position, and various intermediate open positions. When in the closed position (FIG. 1), seating portion 36 of valve element 34 contacts a seating surface 39 provided on main housing body 26 to substantially impeded fluid flow into inlet 30 and through flow passage 24. Conversely, when valve element 34 moves into an open position, valve element 34 lifts from seating surface 39 and fluid is permitted to flow into inlet 30, through flow passage 24, and out of outlets 32.

Compact servo poppet valve 20 further includes one or more spring washers. As used herein, the term “spring washer” is defined to include various low-profile, resilient, compressible elements. A non-exhaustive list of suitable spring washers includes bellville washers, wave springs, and the like. Although compact servo poppet valve 20 may employ a single spring washer, poppet valve 20 preferably comprises multiple spring washers arranged in a stacked configuration. For example, and as shown in FIG. 1, compact servo poppet valve may include a plurality of bellville washers 40 arranged in a stacked configuration. Bellville washers 40 are compressed between an end wall 44 of housing cap 28 and poppet valve element 34 and consequently bias poppet valve element 34 toward the closed position shown in FIG. 1 (i.e., away from end wall 44 of housing cap 28 and toward base wall 33 of main housing body 26). By utilizing two or more bellville washers (or other such spring washers) arranged in such a stacked configuration, the tolerance of compact servo poppet valve 20 may be increased.

If desired, compact servo poppet valve 20 may also be equipped with an adjustable pre-load mechanism. As indicated in FIG. 1, the adjustable pre-load mechanism may comprise, for example, a threaded stop member 42 disposed between end wall 44 of housing cap 28 and bellville washers 40. Threaded stop member 42 threadably engages an inner annular surface of housing cap 28. An aperture 46 is provided through housing cap 28 to permit manual access to threaded stop member 42. A technician may insert a tool (not shown) into aperture 46 to rotate threaded stop member 42 relative to valve housing 22 and thereby adjust the vertical position of threaded stop member 42 relative to end wall 44 of housing cap 28. In this manner, the compressive pre-load exerted by bellville washers 40 on poppet valve element 34 may be adjusted to preference. This example notwithstanding, alternative embodiments of poppet valve 20 may employ other adjustable pre-load mechanisms, such as a shim stack.

To help guide the movement of poppet valve element 34, compact servo poppet valve 20 may be provided with one or more guide features. In the illustrated exemplary embodiment, compact servo poppet valve 20 includes two such guide features. First, main housing body 26 is provided with an annular collar 48 that extends away from base wall 33. Notably, annular collar 48 surrounds seating surface 39, and, when poppet valve element 34 is in the closed position (shown in FIG. 1), poppet valve element 34 resides at least partially within annular collar 48 (e.g., the inner edge of collar 48 may contact an outer circumferential portion of poppet valve element 34). In a preferred embodiment, the outer diameter of annular collar 48 is substantially equivalent to an inner diameter of housing cap 28, and annular collar 48 is substantially co-axial with outlet 30. As noted above, housing cap 28 may be threadably coupled to an outer annular surface of annular collar 48.

Stemmed portion 38 of poppet valve element 34 serves as a second guide feature of compact servo poppet valve 20. As shown in FIG. 1, stemmed portion 38 extends away from seating portion 36 of valve element 34 and is matingly received by a central opening provided in bellville washers 40. In this manner, stemmed portion 38 and bellville washers 40 cooperate to help maintain poppet valve element 34 in its proper position. If desired, stemmed portion 38 may be produced by machining (e.g., grinding) an end portion of poppet valve element 34, which may initially assume the form of a generally spherical body, such as a metal ball.

During operation of compact servo poppet valve 20, poppet valve element 34 normally resides in the closed position shown in FIG. 1. When poppet valve element 34 is in the closed position, little to no fluid is permitted to flow into inlet 30 and through flow passage 24. However, when the pressure exerted by on the area of poppet valve element 34 exposed through inlet 30 exceeds the force exerted on valve element 34 by bellville washers 40 (and, perhaps, by the fluid within flow passage 24), poppet valve element 34 transitions into an open position. Bellville washers 40 are consequently compressed between poppet valve element 34 and threaded stop member 42, and fluid is permitted to flow into inlet 30, through flow passage 24, and out of outlets 32. Poppet valve element 34 remains in an open position until the pressure exerted on poppet valve element 34 by the fluid flowing into inlet 30 is again surpassed by the force exerted on valve element 34 by bellville washers 40 (and any forced exerted on valve element 34 by the fluid within flow passage 24). The characteristics of bellville washers 40 and the dimensions of outlet 30 are chosen to yield a desired threshold pressure at which poppet valve element 34 transitions from the closed position (shown in FIG. 1) to an open position.

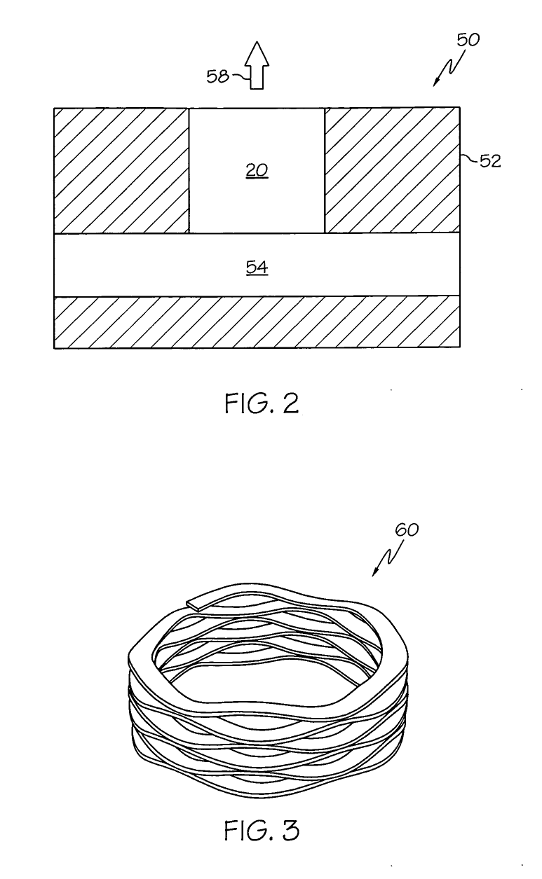

There has thus been provided an exemplary embodiment of a compact servo poppet valve. In the above-described exemplary embodiment, a significant savings in weight and volume of the poppet valve is achieved by utilizing one or more bellville washers as the poppet valve's main return mechanism. The servo poppet valve's modest weight and volume is maintained even when employing bellville washers characterized by a relatively high spring rate. The above-described compact servo valve is consequently well-suited for utilization in applications having significant weight and volume constraints. Embodiments of compact servo valve may find use in a variety of pneumatic or hydraulic control circuits, including, for example, various types of pressure relief systems. To further illustrate this point, an exemplary pressure relief system employing compact servo poppet valve 20 will now be described in conjunction with FIG. 2.

FIG. 2 is a high level schematic of an exemplary pressure relief system 50 employing compact servo poppet valve 20 as a pressure relief valve. In the illustrated example, pressure relief system 50 comprises a system housing 52 containing a pressurized chamber 54 (e.g., a flow passage). Referring collectively to FIGS. 1 and 2, servo poppet valve 20 is fixedly coupled to system housing 52 such that flow passage 24 is fluidly coupled between pressurized chamber 54 and a low pressure source 56. In one embodiment, main housing body 26 (FIG. 1) may be integrally formed with system housing 52. Low pressure source 56 may comprise any fluid body having a pressure lower than that of the fluid within pressurized chamber 54. For example, if pressure relief system 50 conducts pressurized air during operation, low pressure source 56 may simply comprise an ambient air source. Alternatively, low pressure source 56 may comprise an internal chamber of the device in which pressure relief system 50 is employed.

Pressure relief system 50 is configured to maintain the pressure within pressurized chamber 54 below a predetermined pressure threshold (or possibly below a predetermined pressure differential between pressurized chamber 54 and low pressure source 56). As explained above, poppet valve element 34 (FIG. 1) normally resides in the closed position under the bias force of bellville washers 40. When the pressure within chamber 54 surpasses the predetermined pressure threshold, poppet valve element 34 moves from the closed position to an open position. When poppet valve element 34 is in an open position, fluid is permitted to flow from pressurized chamber 54, through compact servo poppet valve 20, and into low pressure source 56 (indicated in FIG. 2 by arrow 58). As a result, the pressure within pressurized chamber 54 is relieved. When the pressure within chamber 54 again falls below the predetermined pressure threshold, poppet valve element 34 returns to the closed position under the force of bellville washers 40 (FIG. 1) and fluid flow through compact servo poppet valve 20 ceases (or is otherwise substantially reduced).

Considering the above, it should be appreciated that there has been provided an exemplary embodiment of a relatively compact and lightweight servo poppet valve employing one or more bellville washers, which may be chosen to have a relatively high spring rate, if desired. It should also be appreciated that there has been provided an exemplary embodiment of a pressure relief system employing such a compact servo poppet valve. As previously noted, additional embodiments of compact servo poppet valve may utilize other types of spring washers (e.g., one or more wave springs) in lieu of, or in addition to, one or more bellville washers to bias the poppet valve element toward the closed position. For example, and with reference to FIG. 3, compact servo poppet valve 20 (FIG. 1) may employ a stack of wave springs 60 in place of bellville washers 40. Stack of wave springs 60 may be joined together in either a crest-to-crest configuration (shown in FIG. 3) or a crest-to-valley configuration (not shown).

While at least one exemplary embodiment has been presented in the foregoing Detailed Description, it should be appreciated that a vast number of variations exist. It should also be appreciated that the exemplary embodiment or exemplary embodiments are only examples, and are not intended to limit the scope, applicability, or configuration of the invention in any way. Rather, the foregoing Detailed Description will provide those skilled in the art with a convenient road map for implementing an exemplary embodiment of the invention. It being understood that various changes may be made in the function and arrangement of elements described in an exemplary embodiment without departing from the scope of the invention as set-forth in the appended claims.

What is claimed is:

1. A servo poppet valve, comprising:
a valve housing having a flow passage therethrough;
a poppet valve element disposed in the flow passage and movable between an open position and a closed position; and
a first spring washer disposed between the valve housing and the poppet valve element and biasing the poppet valve element toward the closed position.

2. A servo poppet valve according to claim 1 wherein the first spring washer comprises a bellville washer.

3. A servo poppet valve according to claim 1 wherein the first spring washer comprises a wave spring.

4. A servo poppet valve according to claim 1 further comprising an adjustable pre-load mechanism disposed between the first spring washer and the valve housing.

5. A servo poppet valve according to claim 4 wherein the adjustable pre-load mechanism comprises a threaded stop member.

6. A servo poppet valve according to claim 1 wherein the valve housing comprises a guide feature for guiding the movement of the poppet valve element.

7. A servo poppet valve according to claim 6 wherein the guide feature comprises an annular collar.

8. A servo poppet valve according to claim 7 wherein the flow passage extends through the annular collar.

9. A servo poppet valve according to claim 1 wherein the poppet valve element includes a stemmed portion that matingly engages the first spring washer.

10. A servo poppet valve, comprising:
a valve housing, comprising:
a main housing body; and
a housing cap fixedly coupled to the main housing body;
a flow passage, comprising:
an inlet formed through the main housing body; and
an outlet formed through the housing cap;
a poppet valve element disposed between the main housing body and the housing cap, the poppet valve element movable between an open position and a closed position; and
at least one spring washer disposed between the housing cap and the poppet valve element and biasing the poppet valve element toward the closed position.

11. A poppet valve according to claim 10 further comprising an adjustable pre-load mechanism disposed between the housing cap and the at least one spring washer.

12. A servo poppet valve according to claim 11 wherein the housing cap includes an aperture therethrough for providing manual access to the adjustable pre-load mechanism.

13. A servo poppet valve according to claim 10 wherein the main housing body includes an annular collar, the poppet valve element residing at least partially within the annular collar when in the closed position.

14. A servo poppet valve according to claim 13 wherein the housing cap is threadably coupled to an outer wall of the annular collar.

15. A servo poppet valve according to claim 13 wherein the main housing body includes a base wall through which the inlet is formed, the annular collar extending away from the base wall.

16. A servo poppet valve according to claim 13 wherein the outer diameter of the annular collar is substantially equivalent to an inner diameter of the housing cap.

17. A servo poppet valve according to claim 10 wherein the at least one spring washer comprises a stack of bellville washers biasing the poppet valve element away from the housing cap.

18. A servo poppet valve according to claim 10 wherein the at least one spring washer comprises a stack of wave springs biasing the poppet valve element away from the housing cap.

19. A pressure relief system for fluid communication with a low pressure source, the pressure relief system comprising:
a system housing having a pressurized chamber therein; and
a servo poppet valve, comprising:
a valve housing fixedly coupled to the system housing;
a flow passage formed through the valve housing and fluidly coupled between the pressurized chamber and the low pressure source;
a poppet valve element disposed in the flow passage and movable between an open position and a closed position, the poppet valve element permitting fluid flow from the pressurized chamber to the low pressure source in the open position; and
a spring washer disposed between the valve housing and the poppet valve element and biasing the poppet valve element toward the closed position, the poppet valve element normally residing in the closed position and configured to move into the open position when the pressure of the fluid within the pressurized chamber surpasses a predetermined pressure threshold.

20. A pressure relief system according to claim 19 wherein the valve housing comprises:
a main housing body integrally formed with the system housing; and
a housing cap threadably coupled to the main housing body.
